(19) United States
(12) Patent Application Publication
(10) Pub. No.: US 2011/0222832 A1
(43) Pub. Date: Sep. 15, 2011

(54) IMAGE PROCESSING DEVICE, IMAGE PROCESSING METHOD, IMAGE PROCESSING SYSTEM, CONTROL PROGRAM, AND RECORDING MEDIUM

(75) Inventor: Tomoyoshi Aizawa, Kyoto-shi (JP)

(73) Assignee: OMRON CORPORATION, Kyoto-shi (JP)

(21) Appl. No.: 13/035,402

(22) Filed: Feb. 25, 2011

(30) Foreign Application Priority Data
Mar. 15, 2010 (JP) 2010-058551

(51) Int. Cl. H04N 5/765

(52) U.S. Cl. 386/200; 386/E05.001

(57) ABSTRACT

An image processing method includes sensing a sound or a frame, in an interested information sensing step, which constitutes a moving image. The sound or frame includes a feature quantity matched with an interested feature quantity. The interested feature quantity is extracted from interested information indicating an item in which a user is interested. The method includes specifying a slot, in an interested scene specifying step, including a reference time point as the interested scene on a reproducing time axis of the moving image. The reference time point is a time of the sound or frame. The sound or frame is sensed in the interested information sensing step. The method includes degrading image quality of a slot, in a low-image quality moving image producing step, except the interested scene specified in the interested scene specifying step in the moving image and producing a low-image-quality moving image of the moving image.

### 1. TECHNICAL FIELD

The present invention relates to an image processing device that transfers moving image data accumulated therein to a mobile terminal, an image processing method, an image processing system, a control program, and a recording medium.

### 2. BACKGROUND

Recently, a storage capacity of a moving image recording device such as a recorder is rapidly increased, and a user can video-record a large amount of moving image data of a television program (video contents). However, when the user cannot secure a time t0 view the television program at home although the large amount of television program is video-recorded in the recorder, unfortunately the user cannot sufficiently view the video-recorded television program even if the user wants to view the television program.

Therefore, in order to solve the problem, there is developed a technique of transferring the moving image data video-recorded by the moving image recording device such as the recorder to a mobile viewing terminal such as a mobile phone which can reproduce the moving image data. For example, in a moving image viewing control device disclosed in Japanese Unexamined Patent Publication No. 2005-277869 (published on Oct. 6, 2005), the moving image distributed from a broadcasting station or a communication station is coded and accumulated, and the accumulated moving image is transferred to the mobile viewing terminal. With such a conventional technique, the user can browse the moving image accumulated by the moving image recording device on the mobile viewing terminal not only at home in which the user can use the moving image recording device but also outside the home.

However, because generally the mobile viewing terminal has a storage capacity smaller than that of the recorder or a PC, there is a restriction to a data amount of moving image that can be transferred from the moving image recording device. That is, occasionally all the pieces of moving image data accumulated in the moving image recording device cannot be stored in the mobile viewing terminal.

Moreover, a transfer time is lengthened with increasing data amount of moving image transferred from the moving image recording device to the mobile viewing terminal. Therefore, as video contents that the user wants to view on the mobile viewing terminal is increased, it takes a long time t0 prepare to view the video contents on the mobile viewing terminal, which degrades the user-friendliness.

When the user wants to view a specific scene of interest in video contents, it is necessary that the user manipulate a mobile viewing terminal to search the specific scene by frequently performing reproduction at fast speed and rewinding reproduction. When the user views the video contents on the mobile viewing terminal, it is inconvenient that the user cannot quickly reproduce the specific scene in which the user is interested because in many cases the user does not have sufficient time. Because battery consumption is increased when the user frequently manipulates the mobile viewing terminal, it is preferred that the user manipulates the mobile viewing terminal as small as possible.

Therefore, there is developed a technique, in which the moving image data of the specific scene (interested scene) in which the user is interested is extracted from the pieces of moving image data of video contents to transmit only the extracted moving image data to the mobile viewing terminal. For example, in a moving image accumulation device disclosed in Japanese Unexamined Patent Publication No. 2004-173120 (published on Jun. 17, 2004), a condition for searching the scene in which the user is particularly interested is previously stored, the accumulated moving image is analyzed based on the stored condition to specify the scene (interested scene) in which the user is particularly interested, and the mobile viewing terminal is notified of the information (selection information) on the specified interested scene. The mobile viewing terminal can receive only the moving image data of the interested scene from the moving image accumulation device using the notified selection information.

Therefore, the data amount transferred from the moving image accumulation device to the mobile viewing terminal can be reduced.

However, in the conventional techniques described above, because the mobile viewing terminal receives only the moving image data of the interested scene, unfortunately the user cannot view the moving images before and after the interested scene on the mobile viewing terminal. Therefore, the user cannot know connections before and after the interested scene such as a background to the interested scene and story after the interested scene.

### SUMMARY

One or more embodiments of the invention provides an image processing device, an image processing method, an image processing system, a control program, and recording medium, in which connections before and after an interested scene is not lost in a moving image while a data amount of moving image transferred from the image processing device to a mobile terminal is reduced.

In accordance with one or more embodiments of the present invention, an image processing device includes: an interested information sensing section for sensing a sound or a frame, which is inputted to the image processing device, the sound or frame constituting a moving image, the sound or frame including a feature quantity matched with an interested feature quantity, the interested feature quantity being extracted from interested information indicating an item in which a user is interested; an interested scene specifying section for specifying a slot including a reference time point as the interested scene on a reproducing time axis of the moving image, the reference time point being a time of the sound or frame, the sound or frame including the interested feature quantity, the sound or frame being sensed by the interested information sensing section; and a low-image-quality moving image producing section for degrading image quality of a slot except the interested scene specified by the interested scene specifying section in the moving image and producing a low-image-quality moving image of the moving image.

In accordance with one or more embodiments of the present invention, an image processing method includes: an interested information sensing step for sensing a sound or a frame, which constitutes a moving image, the sound or frame including a feature quantity matched with an interested feature quantity, the interested feature quantity being extracted from interested information indicating an item in which a user is interested; an interested scene specifying step for specifying a slot including a reference time point as the interested scene on a reproducing time axis of the moving image, the reference time point being a time of the sound or frame, the sound or frame being sensed in the interested information sensing step; and a low-image-quality moving image producing step for degrading image quality of a slot except the interested scene specified in the interested scene specifying step in the moving image and producing a low-image-quality moving image of the moving image.

According to one or more embodiments of the invention, the interested information sensing section senses the sound or frame, which is inputted to the image processing device, the sound or frame constitutes the moving image and includes the feature quantity matched with the interested feature quantity, and the interested feature quantity is extracted from interested information. Because the interested feature quantity is extracted from the interested information indicating the item in which the user is interested, it is believed that the sound or frame including the feature quantity matched with the interested feature quantity is part of the scene in which the user is particularly interested and desires to view. Therefore, the interested scene specifying section specifies the slot including the reference time point as the interested scene on the reproducing time axis of the moving image, and the reference time point is the time of the sound or frame sensed by the interested information sensing section. The low-image-quality moving image producing section degrades the image quality of the slot except the interested scene to produce the low-image-quality moving image of the moving image.

Therefore, in the produced low-image-quality moving image, only the image quality of the slot except the interested scene becomes the low image quality while the image quality of the interested scene in which the user is probably interested is maintained. That is, the produced low-image-quality moving image includes the pieces of information before and after the interested scene while maintaining original image quality for the interested scene in which the user is interested, and the whole data amount is smaller than that of the original moving image. Therefore, the produced low-image-quality moving image can be transferred to another device. In accordance with one or more embodiments disclosed herein, advantageously the user can view the scenes before and after the interested scene on another device while the transfer time is shortened.

In the image processing device according to one or more embodiments of the present invention, the interested scene specifying section preferably specifies a slot between a time point that is a predetermined time before the reference time point and a time point that is a predetermined time after the reference time point as the interested scene.

According to one or more embodiments of the invention, the scene in which the user is interested can be specified as the interested scene by appropriately setting the predetermined time. The user may arbitrarily set the predetermined time, or a specific value may previously be set to the device.

In the image processing device according to one or more embodiments of the present invention, the interested information sensing section senses the sound or frame, which is inputted to the image processing device, the sound or frame constituting the moving image, the sound or frame including a feature quantity matched with an uninterested feature quantity, the uninterested feature quantity being extracted from uninterested information relating to a scene in which a user is not interested, and the interested scene specifying section preferably sets a time after the reference time point in a time of the sound or frame including the uninterested feature quantity as an ending time point of the interested scene, the time of the sound or frame being sensed by the interested information sensing section.

According to one or more embodiments of the invention, the time point, in which the uninterested feature quantity extracted from the uninterested information indicating the information relating to the scene in which the user is not interested is sensed, is set to the ending time point of the interested scene. That is, the interested scene is ended at the time point when the scene in which the interested item of the user is shown is switched to the scene in which the user is not interested. Therefore, the slot in which the scene in which the interested item of the user appears can efficiently and automatically be specified as the interested scene.

The image processing device according to one or more embodiments of the present invention further includes scene switching time point detection section for detecting a scene switching time point at which an image change amount between frames becomes a predetermined amount or more, wherein the interested scene specifying section preferably selects at least one of the start time point and the ending time point of the slot of the interested scene from the scene switching time point detected by the scene switching time point detection section.

According to one or more embodiments of the invention, the interested scene specifying section selects at least one of the start time point and ending time point of the slot of the interested scene from the scene switching time point at which the image change amount between the frames becomes the predetermined value or more in the moving image. It is predicted that contents before and after the scene switching time point are largely changed in the moving image. Therefore, the slot in which the scene in which the interested item of the user is shown can efficiently and automatically be specified as the interested scene by setting the scene switching time point to one of the start time point and ending time point of the slot of the interested scene.

In the image processing device according to one or more embodiments of the present invention, the interested scene specifying section preferably selects the scene switching time point immediately before the reference time point and the scene switching time point immediately after the reference time point as the start time point and the ending time point of the slot of the interested scene from a plurality of scene switching time points detected by the scene switching time point detection section, respectively.

According to one or more embodiments of the invention, the interested scene specifying section selects the scene switching time point immediately before the reference time point and the scene switching time point immediately after the reference time point as the start time point and ending time point of the slot of the interested scene, respectively. Therefore, the time points at which contents are largely changed immediately before and immediately after the time at which the interested item of the user is shown are selected as the start time point and ending time point of the slot of the interested scene. Accordingly, the slot in which the interested item of the user is shown can efficiently and automatically be specified as the interested scene.

In the image processing device according to the present invention, the interested scene specifying section preferably selects a start time point and an ending time point of the slot from the plurality of scene switching time points such that the slot of the interested scene becomes a predetermined time or more.

According to one or more embodiments of the invention, the interested scene specifying section selects the start time point and ending time point of the slot from the plurality of scene switching time points such that the slot of the interested scene becomes the predetermined time or more. For example, even if the interested item of the user is the plurality of continuous scenes different from each other, the interested scene can be set by appropriately setting the predetermined time such that the scene within the predetermined time before and after the time at which the interested item of the user is shown is included.

In the image processing device according to one or more embodiments of the present invention, the interested information preferably includes at least one of text data, image data, and sound data.

In the image processing device according to one or more embodiments of the present invention, the low-image-quality moving image producing section preferably decreases resolution of the slot except the interested scene specified by the interested scene specifying section in the moving image.

In the image processing device according to one or more embodiments of the present invention, the low-image-quality moving image producing section preferably increases a moving image compression ratio of the slot except the interested scene specified by the interested scene specifying section in the moving image.

In the image processing device according to one or more embodiments of the present invention, the low-image-quality moving image producing section preferably decreases a frame rate of the slot except the interested scene specified by the interested scene specifying section in the moving image.

In the image processing device according to one or more embodiments of the present invention, the low-image-quality moving image producing section preferably compares an image of a predetermined frame and a frame image before the predetermined frame and decreases the frame rate by thinning out the predetermined frame whose image change amount between frames is lower than a predetermined threshold.

In accordance with one or more embodiments of the invention, an image processing system includes: the image processing device; and a mobile terminal that can reproduce a moving image, wherein the image processing device transfers the produced low-image-quality moving image to the mobile terminal.

In the image processing system according to one or more embodiments of the present invention, the image processing device preferably transfers information indicating the slot of the interested scene in the moving image to the mobile terminal.

According to one or more embodiments of the invention, the image processing device transfers the information indicating the slot of the interested scene of the moving image to the mobile terminal. Therefore, the mobile terminal can clearly learn the start time point and ending time point of the slot of the interested scene in the received low-image-quality moving image. Therefore, when the user reproduces the low-image-quality moving image on the mobile terminal, it is not necessary to search the interested scene while frequently performing the reproduction at fast speed and rewinding reproduction, which allows the user to view only the interested scene with a simple manipulation. Because the user's manipulation amount is reduced, the power consumed in the mobile terminal can also be reduced.

The image processing method according to one or more embodiments of the present invention further includes a transfer step of transferring the low-image-quality moving image produced in the low-image-quality moving image producing step to a mobile terminal.

In accordance with one or more embodiments of the invention, the image processing device may be implemented by a computer. In such cases, a control program for the image processing device, which causes the computer to act as each of the above-described sections to implement the image processing device, and a computer-readable recording medium in which the control program is recorded are also included in the scope of the present invention.

As described above, an image processing device according to one or more embodiments of the present invention includes: an interested information sensing section for sensing a sound or a frame, which is inputted to the image processing device, the sound or frame constituting a moving image, the sound or frame including a feature quantity matched with an interested feature quantity, the interested feature quantity being extracted from interested information indicating an item in which a user is interested; an interested scene specifying section for specifying a slot including a reference time point in which the interested feature quantity is sensed as the interested scene in the moving image; and a low-image-quality moving image producing section for degrading image quality of a slot except the interested scene specified by the interested scene specifying section in the moving image and producing a low-image-quality moving image of the moving image.

An image processing method according to one or more embodiments of the present invention includes: an interested information sensing step for sensing, from a sound or a frame which constitutes a moving image, an interested feature quantity being extracted from interested information indicating an item in which a user is interested; an interested scene specifying step for specifying as the interested scene a slot including at least a reference time point in which the interested feature quantity is sensed in the moving image; and a low-image-quality moving image producing step for degrading image quality of a slot except the interested scene specified in the interested scene specifying step in the moving image and producing a low-image-quality moving image of the moving image.

In accordance with one or more embodiments of the invention, when the produced low-image-quality moving image is transferred to another device such as the mobile terminal, advantageously the scenes before and after the interested scene can be viewed on another device while the transfer time can be shortened.

### BRIEF DESCRIPTION OF THE DRAWINGS

FIG. 1 is a block diagram showing a configuration of a main part of a DVD recorder according to one or more embodiments of the present invention;

FIG. 2 is a view showing an outline of an image processing system according to one or more embodiments of the present invention;

FIG. 3 is a view showing an example of character information stored in a character information storage unit;

FIG. 4 is a view showing an example of a reference frame stored in a reference frame storage unit;

FIG. 5 is a view showing an example of information (interested scene list) on an interested scene stored in an interested scene storage unit;

FIG. 6 is a block diagram showing a configuration of a main part of a mobile phone according to one or more embodiments of the present invention;

FIG. 7 is a flowchart showing an example of processing performed by the DVD recorder;

FIG. 8 is a view explaining appearances of the DVD recorder, a display device (television), and a manipulation unit (remote controller) in accordance with one or more embodiments of the present invention and a state in which a user inputs a target keyword (character string);

FIG. 9 is a view showing an example of a search target region that is used to search a next character with respect to an already-sensed character; and

FIG. 10 is a view showing an example of a slot of the interested scene and a slot except the interested scene.

### DETAILED DESCRIPTION

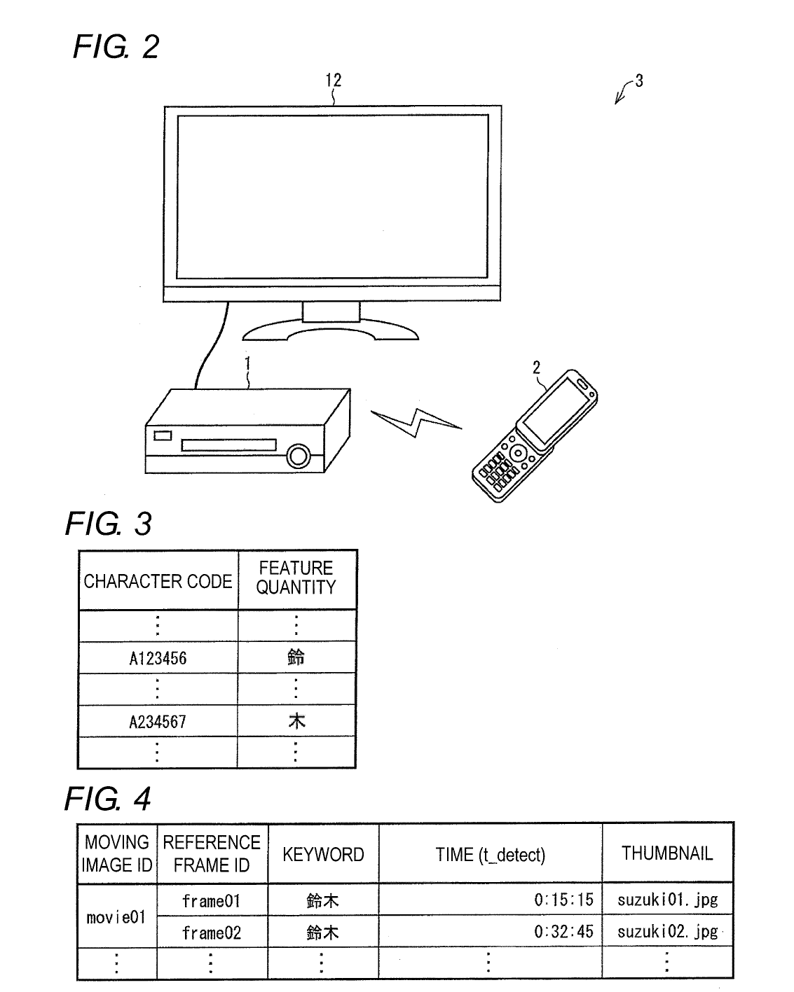

Hereinafter, one or more embodiments of the present invention will be described with reference to the drawings. An outline of an image processing system 3 according to one or more embodiments of the invention will be described with reference to FIG. 2.

[Outline of Image Processing System]

FIG. 2 is a view showing an outline of the image processing system 3 in accordance with one or more embodiments of the invention. As shown in FIG. 2, the image processing system 3 includes an image processing device 1 and a mobile terminal 2. The image processing device 1 and the mobile terminal 2 are connected by wired or wireless communication means, and moving image data can be transmitted and received between the image processing device 1 and the mobile terminal 2. For example, the image processing device 1 and the mobile terminal 2 may transmit and receive data to and from each other through a wireless LAN, or the image processing device 1 and the mobile terminal 2 may be connected by a USB cable. The image processing device 1 and the mobile terminal 2 may conduct data communication with each other using a memory card such as an SD card. In the present embodiment, by way of example, the image processing device 1 is a DVD recorder 1 that video-records the moving image and reproduces and displays the video-recorded moving image, and the mobile terminal 2 is a mobile phone 2 that can reproduce the moving image.

The image processing device 1 of the present embodiment is not limited to the DVD recorder, but can be applied to any image processing device that can process the image. For example, although not limited thereto, the image processing device 1 can be applied to various image processing devices, such as a DVD player, a digital video recorder/player, a Blu-ray disk recorder/player, a digital video camera, a digital camera, a digital television, a personal computer, a mobile phone, a printer, and a scanner, which process the still image and/or the moving image. The mobile terminal 2 of the present invention is not limited to the mobile phone, but can be applied to any portable mobile terminal that can reproduce the moving image. For example, although not limited thereto, the mobile terminal 2 can be applied to various mobile terminals, such as a digital video camera, a digital camera, a PDA (Personal Digital Assistant), a notebook personal computer, and a mobile game machine, which have a moving image reproducing function.

As shown in FIG. 2, the image processing system 3 may include a display device 12 that displays a keyword input screen and the like in order to improve operability of the image processing device 1. The image processing device 1 and the display device 12 are connected by wired or wireless communication means, and the image processing device 1 and the display device 12 transmit and receive the moving image data and the like to and from each other. In the present embodiment, by way of example, the display device 12 is a digital television that displays the moving image and a menu screen.

Specifically, the display device 12 displays an image processed by the image processing device 1, and displays a manipulation screen as a GUI (Graphical User Interface) screen in order that a user manipulates the image processing device 1.

The display device 12 of the present invention is not limited to the digital television, but any display device may be used as long as the display device can display the image. For example, although not limited thereto, various display devices, such as an LCD (Liquid Crystal Display), an organic EL display, and a plasma display, which display the image, can be applied to the display device 12.

When the image processing system 3 includes the display device 12, the image processing device 1 and the display device 12 are separately provided as shown in FIG. 2 although not limited thereto. For example, the image processing device 1 may include the display unit to have the function of the display device 12.

[Configuration of DVD Recorder]

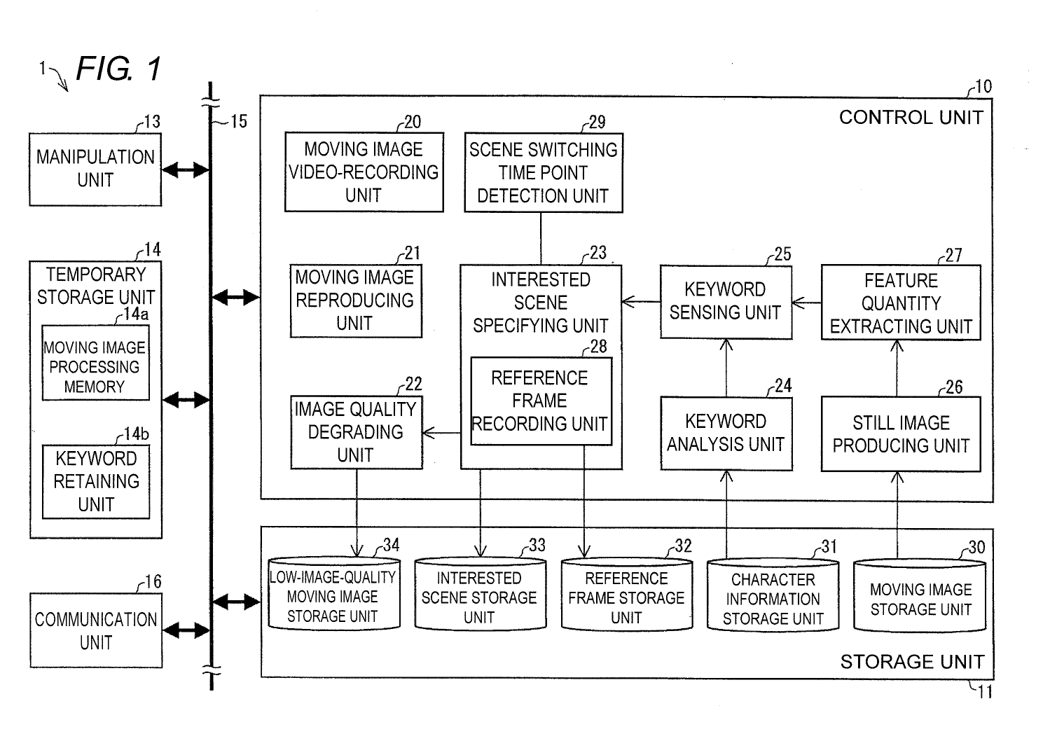

In accordance with one or more embodiments of the invention, a configuration of the DVD recorder 1 that is the image processing device 1 will be described with reference to FIG. 1. FIG. 1 is a block diagram showing a configuration of a main part of the DVD recorder 1 in accordance with one or more embodiments of the present invention.

As shown in FIG. 1, the DVD recorder 1 of one or more embodiments includes a control unit 10, a storage unit 11, a manipulation unit 13, a temporary storage unit 14, a communication unit 16, and a bus 15 serving as a common signal line through which the units transmit and receive data to and from one another.

The manipulation unit 13 is used when the user inputs an instruction signal to the DVD recorder 1 to manipulate the DVD recorder 1.

The DVD recorder 1 may include the manipulation unit 13 that can directly transmit and receive the data through the bus 15, but the DVD recorder 1 is not limited to such a configuration.

In the present embodiment, by way of example, the manipulation unit 13 may be implemented as a remote controller common to the digital television and the DVD recorder 1. A signal corresponding to a button (an arrow key, an enter key, and a character input key) provided in the manipulation unit 13 is outputted as an infrared signal from a light emitting unit of the manipulation unit 13 when the button is pressed down, and the signal is inputted to the DVD recorder 1 or digital television through a light receiving unit that is provided in the DVD recorder 1 or a main body of the digital television. The signal received through the light receiving unit (not shown) of the DVD recorder 1 is supplied to the control unit 10 through the bus 15, and the control unit 10 performs an operation according to the signal.

The communication unit 16 conducts communication with other devices such as the mobile phone 2 and the display device 12 through the wireless or wired communication means in order to transmit and receive the data. For example, the communication unit 16 may include functions of an antenna and a tuner to receive a radio wave of television. For example, the communication unit 16 may act as an external interface to be connected to the display device 12 through an HDMI (High Definition Multimedia Interface) cable or the like. For example, the communication unit 16 may act as an external interface to receive the moving image data from a PC, a memory card, and a flash memory, which are connected to the communication unit 16, or to output the moving image data to the PC, memory card, and flash memory, which are connected the communication unit 16.

The control unit 10 executes a program that is read from the storage unit 11 to the temporary storage unit 14, whereby various calculations are performed while the units of the DVD recorder 1 are totally controlled through the bus 15.

In one or more embodiments, the control unit 10 includes a moving image video-recording unit 20, a moving image reproducing unit 21, an image quality degrading unit (low-image-quality moving image producing section) 22, an interested scene specifying unit (interested scene specifying section) 23, a keyword analysis unit 24, a keyword sensing unit (interested information sensing section) 25, a still image producing unit 26, a feature quantity extracting unit 27, and a scene switching time point detection unit (scene switching time point detection section) 29 as functional blocks. The functional blocks 20 to 27 of the control unit 10 can be realized such that a CPU (Central Processing Unit) reads the program stored in the storage device implemented by a ROM (Read Only Memory) to the temporary storage unit 14 implemented by a RAM (Random Access Memory) or the like and executes the program.

The moving image video-recording unit 20 stores the moving image received by the communication unit 16 in a moving image storage unit 30.

The moving image reproducing unit 21 reads the moving image stored in the moving image storage unit 30 and reproduces the moving image by performing external output processing to the moving image. When an instruction to reproduce and display the moving image is inputted, the moving image processed by the moving image reproducing unit 25 is once stored in the image memory 14a, and the moving image is outputted in each frame to the display device 12 through the communication unit 16 under the control of a display control unit (not shown).

The image quality degrading unit 22 reads the moving image stored in the moving image storage unit 30, and relatively raises image quality of an interested scene specified by the interested scene specifying unit 23 while relatively degrading the image quality of a scene except the interested scene. Specifically, the image quality degrading unit 22 may relatively raise the resolution of the image data with respect to the interested scene while relatively degrading the resolution of the image data with respect to the scene except the interested scene. The image quality degrading unit 22 may relatively degrade a moving image compression ratio with respect to the interested scene while relatively raising the moving image compression ratio with respect to the scene except the interested scene. The image quality degrading unit 22 may relatively raise a frame rate with respect to the interested scene while relatively degrading the frame rate with respect to the scene except the interested scene. The image quality degrading unit 22 compares an image of a predetermined frame to images before and after the predetermined frame, and the image quality degrading unit 22 may degrade the frame rate by thinning out the predetermined frame in which an image change amount between frames is lower than a predetermined threshold.

The interested scene specifying unit 23 specifies a slot including a reference time point that is a time of a sound or a frame, which is sensed by the keyword sensing unit 25, as the interested scene on a reproducing time axis of the moving image. The interested scene specifying unit 23 may specify, as the interested scene, the slot between the time point that is a predetermined time before the reference time point and the time point that is a predetermined time after the reference time point. The interested scene specifying unit 23 may set the time point, at which the uninterested feature quantity is sensed after the time point of the reference frame sensed by the keyword sensing unit 25, to an ending time point of the interested scene. The interested scene specifying unit 23 may select one of a start time point and the ending time point of the slot of the interested scene from a scene switching time point detected by the scene switching time point detection unit 29. The interested scene specifying unit 23 may select the scene switching time point immediately before the reference time point and the scene switching time point immediately after the reference time point as the start time point and ending time point of the slot of the interested scene from the plurality of scene switching time points detected by the scene switching time point detection unit 29, respectively. The interested scene specifying unit 23 may select the start time point and ending time point of the slot of the interested scene from the plurality of scene switching time points detected by the scene switching time point detection unit 29 such that the slot of the interested scene becomes a predetermined time or more.

The interested scene specifying unit 23 may include a reference frame recording unit 28.

The keyword analysis unit 24 extracts an interested feature quantity from interested information, which is inputted to the DVD recorder 1 and indicates an item in which the user is interested. The keyword analysis unit 24 extracts an uninterested feature quantity from uninterested information, which is inputted to the DVD recorder 1 and indicates information relating to a scene in which the user is not interested. In this case, the interested information and the uninterested information are pieces of data that include at least one of text data, image data, and sound data. In the present embodiment, by way of example, the interested information and the uninterested information are keywords (character string, that is, text data).

When the interested information and the uninterested information are pieces of text data, the keyword analysis unit 24 searches a character code identical to that of the keyword inputted to the DVD recorder 1 from character codes included in character information stored in a character information storage unit 31, and the keyword analysis unit 24 extracts a feature quantity, which is matched with the character code of the keyword to be correlated with the character code included in the character information, as the feature quantity of the keyword inputted to the DVD recorder 1.

When the interested information and the uninterested information are pieces of image data, the keyword analysis unit 24 extracts the feature quantity of the image data inputted to the DVD recorder 1 using the technique disclosed in Masatoshi Okutomi, et al., “Digital Image Processing”, CG-ARTS Society Press, 1, March 2007 (2nd edition, 2nd print), P. 208 to 210, Section 12-2 “Feature Point Detection” hereby incorporated by reference in it's entirety. When the interested information and the uninterested information are pieces of sound data, the keyword analysis unit 24 converts the sound data into the text data and similarly extracts the feature quantity of the text data.

In accordance with one or more embodiments of the invention, the keyword sensing unit 25 senses the sound or frame constituting the moving image and including the feature quantity that is matched with the interested feature quantity extracted by the keyword analysis unit 24. The keyword sensing unit 25 also senses the sound or frame constituting the moving image and including the feature quantity that is matched with the uninterested feature quantity extracted by the keyword analysis unit 24. In the present embodiment, the keyword sensing unit 25 senses the interested feature quantity and the uninterested feature quantity from a still image that is the frame constituting the moving image.

When the keyword sensing unit 25 senses the sound constituting the moving image, which includes the feature quantity matched with the interested feature quantity (or uninterested feature quantity), a sound data extracting unit (not shown) extracts the sound data from the moving image stored in the moving image storage unit 30. Then, the feature quantity extracting unit 27 extracts the text data as the feature quantity from the sound data. On the other hand, the keyword analysis unit 24 also extracts the text data as the feature quantity from the interested information and the uninterested information. The keyword sensing unit 25 senses whether the pieces of text data as the feature quantities of the interested information and uninterested information are included in the text data that is extracted from the sound data extracted from the moving image.

The still image producing unit 26 produces the still image of a keyword sensing processing target by extracting the frame of the processing target from the frames of the moving image stored in the moving image storage unit 30. The still image producing unit 26 may put all the frames included in the moving image in the still images. However, in the present embodiment, processing for extracting the still image of the processing target is performed at predetermined time intervals of seconds or at predetermined intervals of frames.

The feature quantity extracting unit 27 extracts the feature quantity used in the keyword sensing processing from the still image produced by the still image producing unit 26 using the technique disclosed in Masatoshi Okutomi, et al., “Digital Image Processing”, CG-ARTS Society Press, 1, March 2007 (2nd edition, 2nd print), P. 208 to 210, Section 12-2 “Feature Point Detection”. Any feature quantity may be used in the DVD recorder 1 in accordance with one or more embodiments of the present invention as long as the keyword sensing unit 25 can sense whether the interested information (uninterested information) such as the text data, image data, and sound data which is inputted to the DVD recorder 1 is included in the sound or frame constituting the moving image.

The reference frame recording unit 28 stores the information on the reference frame specified by the interested scene specifying unit 23 in a reference frame storage unit 32. Specifically, the reference frame recording unit 28 stores a reference frame ID, the keyword used in detecting the reference frame, the time (time point) of the reference frame, and the image (thumbnail) of the reference frame as the information on the reference frame in the reference frame storage unit 32.

The scene switching time point detection unit 29 detects the scene switching time point at which the image change amount between the frames becomes a predetermined value or more in the moving image. Specifically, the scene switching time point detection unit 29 compares an image of a frame image and images of images before and after the frame to compute the image change amount (such as a difference between two images) between the frames, and determines whether the computed image change amount exceeds a predetermined threshold (scene switching threshold). The time (time point) of the frame in which the scene switching time point detection unit 29 determines that the computed image change amount exceeds the predetermined threshold is detected as the scene switching time point.

A control program and an OS program, which are executed by the control unit 10, and various pieces of fixed data, which are read when the control unit 10 performs various functions (such as interested scene specifying processing and image quality degrading processing) possessed by the DVD recorder 1, are stored in the storage unit 11. In the present embodiment, for example, the storage unit 11 includes the moving image storage unit 30, the character information storage unit 31, the reference frame storage unit 32, an interested scene storage unit 33, and a low-image-quality moving image storage unit 34, and the various pieces of fixed data are stored in the storage unit 11. The storage unit 11 is implemented by a nonvolatile memory, such as an EPROM (Erasable Programmable ROM), an EEPROM (Electrically EPROM), and a flash memory, in which contents can be rewritten. As described above, the storage unit in which the information that is not necessary to rewrite contents may be implemented by a ROM that is a read-only semiconductor memory (not shown) different from the storage unit 11.

The moving image video-recorded by the moving image video-recording unit 20 is stored in the moving image storage unit 30.

The pieces of information on the characters, which are used when the keyword sensing unit 25 performs keyword sensing processing, are stored in the character information storage unit 31, and the character information storage unit 31 acts as a character database. FIG. 3 is a view showing an example of the character information stored in the character information storage unit 31. As shown in FIG. 3, the character code and the feature quantity of the character are stored in each character in the character information storage unit 31 in order to identify the character.

Information (reference frame list) on the reference frame is stored in the reference frame storage unit 32. The reference frame list includes items of “moving image ID”, “reference frame ID”, “keyword”, “time (t_detect)”, and “thumbnail”. The reference frame list may include at least the item of “time (t_detect)”. The item of “moving image ID” is identification information that is used to identify the moving image. The item of “reference frame ID” is identification information that is used to identify the reference frame specified by the interested scene specifying unit 23. The item of “keyword” is a keyword that is used in sensing the correlated reference frame, and the character string of the keyword is stored in the item of “keyword”. The item of “time (t_detect)” is a time (reference time point) of the correlated reference frame, and the time of the reference time point on the moving image is stored in the item of “time (t_detect)”. The item of “thumbnail” is an image of the correlated reference frame, and a file name of the image is stored in the item of “thumbnail”.

Information (interested scene list) on the interested scene specified by the interested scene specifying unit 23 is stored in the interested scene storage unit 33. The interested scene list includes items of “moving image ID”, “interested scene ID”, “keyword”, “start time”, “ending time”, and “thumbnail”. The interested scene list may include at least the items of “start time” and “ending time”. The item of “moving image ID” is identification information that is used to identify the moving image. The item of “interested scene ID” is identification information that is used to identify the interested scene specified by the interested scene specifying unit 23. The item of “keyword” is a keyword that is used to sense the reference frame in specifying the correlated interested scene, and the character string of the keyword is stored therein. The item of “start time” indicates the start time point of the slot of the interested scene, and the time on the moving image of the start time point is stored therein. The item of “ending time” indicates the ending time point of the slot of the interested scene, and the time on the moving image of the ending time point is stored therein. The item of “thumbnail” is an image of the reference frame that is used as a reference in specifying the correlated interested scene, and the file name of the image is stored therein. Not the image of the reference frame but any image of the frame included in the slot of the interested scene may be used as the item of “thumbnail”. For example, the image of the frame of the start time point or ending time point of the slot of the interested scene may be used as the item of “thumbnail”.

The low-image-quality moving image produced by the image quality degrading unit 22 is stored in the low-image-quality moving image storage unit 34.

The temporary storage unit 14 is a so-called working memory in which data used in computation and computation result are temporarily stored in processes of various pieces of processing performed by the DVD recorder 1, and the temporary storage unit 14 is implemented by a RAM (Random Access Memory) or the like. More specifically, the still image producing unit 26 expands the image that becomes the processing target to an image memory 14a of the temporary storage unit 14 when the image processing is performed, which allows the feature quantity extracting unit 27 to finely analyze the image in units of pixels. When the keyword analysis unit 24 extracts the feature quantity of the keyword based on the keyword inputted by the user, the inputted keyword is temporarily stored in a keyword retaining unit 14b of the temporary storage unit 14.

[Configuration of Mobile Phone 2]

A configuration of the mobile phone 2 that is the mobile terminal 2 will be described below with reference to FIG. 6 in accordance with one or more embodiments of the invention. FIG. 6 is a block diagram showing a configuration of a main part of the mobile phone 2 according one or more embodiments of the present invention.

As shown in FIG. 6, the mobile phone 2 of one or more embodiments includes a control unit 40, a storage unit 41, a display unit 42, a manipulation unit 43, a temporary storage unit 44, a communication unit 46, and a bus 45 that is a common signal line through which the units transmit and receive data to and from one another.

The display unit 42 displays the image processed by the mobile phone 2, and displays a manipulation screen as the GUI (Graphical User Interface) screen in order that the user manipulates the mobile phone 2. For example, the display unit 42 is formed by a display device such as the LCD (Liquid Crystal Display) and the organic EL display.

The manipulation unit 43 is used when the user inputs an instruction signal to the mobile phone 2 to manipulate the mobile phone 2. In the present embodiment, for example, the manipulation unit 43 is formed by an arrow key, a numerical keypad, and a function key.

The communication unit 46 conducts communication with other devices such as the image processing device 1 through the wireless or wired communication means in order to transmit and receive the data.

The control unit 40 executes a program that is read from the storage unit 41 to the temporary storage unit 44, whereby various calculations are performed while the units of the mobile phone 2 are totally controlled through the bus 45.

The control unit 40 includes a moving image receiving unit 51 and a moving image reproducing unit 52 as functional blocks. The functional blocks 51 and 52 of the control unit 40 can be realized such that a CPU reads the program stored in the storage device implemented by a ROM to the temporary storage unit 44 implemented by a RAM and executes the program.

The moving image receiving unit 51 receives the low-image-quality moving image, transferred from the DVD recorder 1, through the communication unit 46 to store the received low-image-quality moving image in a moving image storage unit 61. When the interested scene list is transferred from the DVD recorder 1 along with the low-image-quality moving image, the moving image receiving unit 51 receives the low-image-quality moving image and interested scene list through the communication unit 46, and stores the received low-image-quality moving image in the moving image storage unit 61 while storing the received interested scene list in an interested scene storage unit 62.

The moving image reproducing unit 52 reproduces the moving image or low-image-quality moving image, which is stored in the moving image storage unit 61. When reproducing the low-image-quality moving image, the moving image reproducing unit 52 can refer to the interested scene list stored in the interested scene storage unit 62 to specify the slot of the interested scene in the low-image-quality moving image.

A control program and an OS program, which are executed by the control unit 40, and various pieces of fixed data, which are read when the control unit 40 performs various functions (such as moving image reproducing processing) possessed by the mobile phone 2, are stored in the storage unit 41. In the present embodiment, for example, the storage unit 41 includes the moving image storage unit 61 and the interested scene storage unit 62, and the various pieces of fixed data are stored in the storage unit 41. The storage unit 41 is implemented by a nonvolatile memory, such as an EPROM, an EEPROM, and a flash memory, in which contents can be rewritten. As described above, the storage unit in which the information that is not necessary to rewrite contents may be implemented by a ROM that is a read-only semiconductor memory (not shown) different from the storage unit 41.

The moving image or the low-image-quality moving image transferred from the DVD recorder 1 is stored in the moving image storage unit 61.

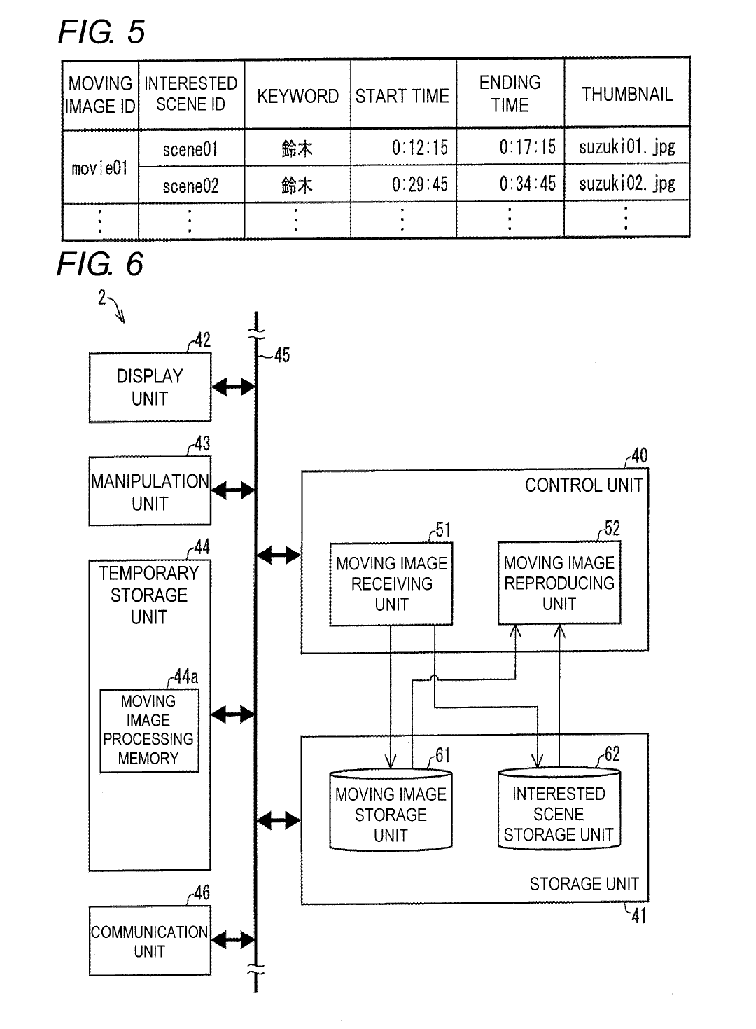

The interested scene list transferred from the DVD recorder 1 is stored in the interested scene storage unit 62. A data structure of the interested scene list stored in the interested scene storage unit 62 is similar to the interested scene list shown in FIG. 5, which is stored in the interested scene storage unit 33 of the DVD recorder 1.

The temporary storage unit 44 is a so-called working memory in which the data used in computation and the computation result are temporarily stored in the processes of various pieces of processing performed by the mobile phone 2, and the temporary storage unit 44 is implemented by a RAM or the like. More specifically, the moving image reproducing unit 52 expands the moving image that becomes the processing target to a moving image processing memory 44a of the temporary storage unit 44 when the moving image is reproduced, which allows the moving image reproducing unit 52 to read the interested scene list from the interested scene storage unit 62 to smoothly specify the slot of the interested scene.

[Processing of DVD Recorder 1]

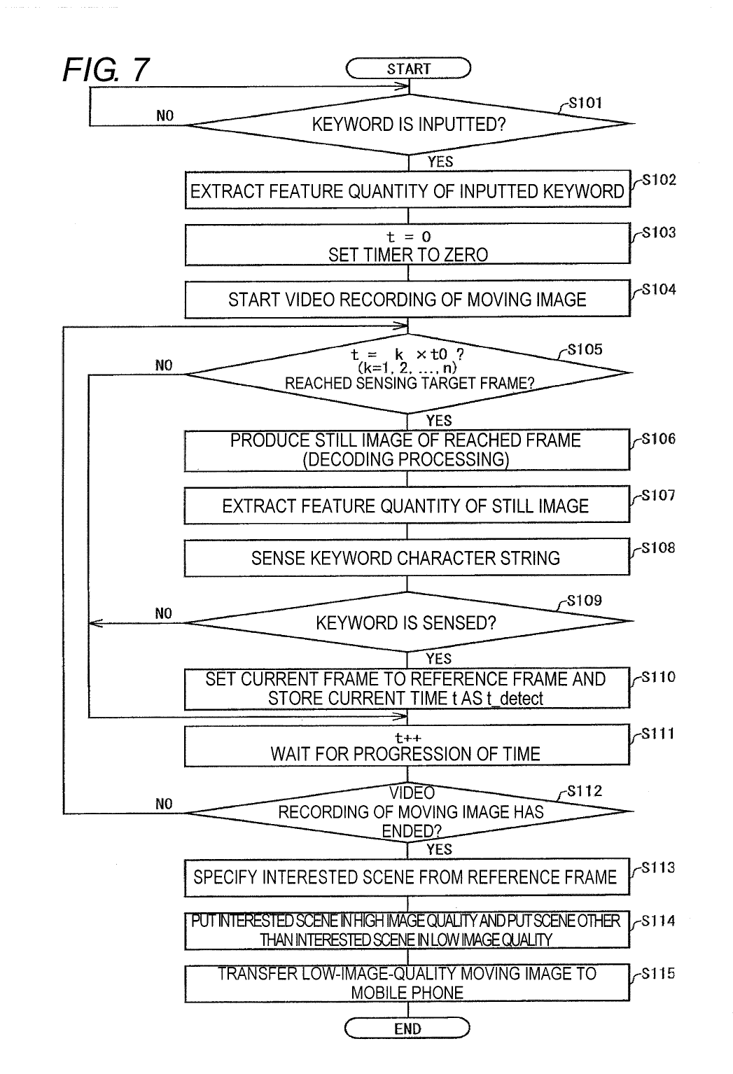

Then, interested scene specifying processing and image quality degrading processing of the DVD recorder 1 will be described with reference to FIG. 7 in accordance with one or more embodiments of the invention. FIG. 7 is a flowchart showing an example of processing performed by the DVD recorder 1.

The keyword analysis unit 24 waits for the keyword inputted from the user through the manipulation unit 13 (S101). When the keyword is inputted through the manipulation unit 13 (YES in S101), the keyword analysis unit 24 refers to the character information storage unit 31 to extract the feature quantity (interested feature quantity) of the inputted keyword (interested information) (S102).

The control unit 10 sets (initializes) a timer to zero 0 (S103), and the moving image video-recording unit 20 starts to count the timer while starting the video recording of the moving image received through the communication unit 16 (S104).

When the video recording of the moving image is started, the still image producing unit 26 waits for a time t of the timer to become a time t0 (S105). When the time t of the timer becomes the time t0 (YES in S105), the still image producing unit 26 reads the moving image frame at the time t0 from the moving image storage unit 30 in which the moving image video-recorded by the moving image video-recording unit 20 is stored, and produces the still image of the read moving image frame (S106). The feature quantity extracting unit 27 extracts the feature quantity of the still image produced by the still image producing unit 26 (S107).

The keyword sensing unit 25 compares the feature quantity extracted by the feature quantity extracting unit 27 and the feature quantity extracted by the keyword analysis unit 24 to determine whether the inputted keyword is included in the still image produced by the still image producing unit 26 (S108). When the keyword sensing unit 25 senses the keyword (YES in S109), the interested scene specifying unit 23 sets the frame, which is the still image whose keyword is sensed, to the reference frame, and sets the time t of the reference frame to t_detect (reference time point). The reference frame recording unit 28 records the still image of the reference frame, the time of the reference frame, the keyword used in the detection in the reference frame storage unit 32 while correlating the still image of the reference frame, the time of the reference frame, the keyword used in the detection with the reference frame ID (S110).

When the keyword cannot be sensed in S109 (NO in S109), or when the reference frame storage unit 32 records the time t of the reference frame in S110, waits for the progression of the time (S111), and the moving image video-recording unit 20 does not end the video recording (NO in S112), the DVD recorder 1 waits for the time t0 become 2×t0 (S105). When the time becomes 2×t0 (YES in S105), the still image producing unit 26 reads the moving image frame at the time 2×t0 from the moving image storage unit 30 to produce the still image (S106). Then, similarly to the time t0, the feature quantity is extracted to sense whether the keyword is included. When the keyword can be sensed, the moving image frame at the time 2×t0 is set to the reference frame, and the time t of the reference frame is stored as t_detect.

That is, the still image producing unit 26 reads the moving image frame from the moving image storage unit 30 to produce the still image at constant time intervals (t0). Hereinafter, the moving image frame that is read by the still image producing unit 26 at constant time intervals is referred to as a sensing target frame. The keyword sensing unit 25 senses whether the keyword is included. When the keyword is sensed, the sensing target frame of the current time (k×t0 (k=1, 2, . . . , and n)) is stored as the reference frame in the interested scene specifying unit 23. The sequence of pieces of processing S105 to S111 is performed until the moving image video-recording unit 20 ends the video recording.

When the moving image video-recording unit 20 ends the video recording of the moving image (YES in S112), the interested scene specifying unit 23 sets a time that is a predetermined time t1 before the time t_detect (reference time point) of the reference frame to the time t_start, a time that is a predetermined time t2 after the time tdetect of the reference frame to the time t_end, and the frames included in a period from the time t_start to the time t_end as the interested scene (S113). The interested scene specifying unit 23 stores the start time and the ending time of the specified interested scene, the thumbnail of the interested scene, and the keyword used to specify the interested scene in the interested scene storage unit 33 while correlating the start time and ending time, the thumbnail, and the keyword with the interested scene ID.

The image quality degrading unit 22 refers to the start time (start time point) and ending time (ending time point) of the interested scene to classify the moving image video-recorded in the moving image storage unit 30 into interested scene and the scene except the interested scene, the image quality degrading unit 22 puts the scene except the interested scene into the low image quality, and the image quality degrading unit 22 produces the low-image-quality moving image from the moving image to store the low-image-quality moving image in the low-image-quality moving image storage unit 34 (S114).

The control unit 10 transmits the low-image-quality moving image produced by the image quality degrading unit 22 to the mobile phone 2 through the communication unit 16 (S115).

That is, in the moving image, the scene except the interested scene is put in the low-image-quality moving image whose image quality is degraded relative to the interested scene, whereby the moving image including the scenes before and after the scene (interested scene) in which the user is interested while the amount of data transferred from the DVD recorder 1 to the mobile phone 2 is reduced. Therefore, the transfer time from the DVD recorder 1 to the mobile phone 2 can be shortened. Additionally, the connections before and after the interested scene can be viewed when the user performs the reproduction with the mobile phone 2.

The control unit 10 may transmit the interested scene list stored in the interested scene storage unit 33 to the mobile phone 2 while transmitting the low-image-quality moving image produced by the image quality degrading unit 22 to the mobile phone 2 through the communication unit 16.

In this case, the mobile phone 2 can specify where the interested scene is located in the received low-image-quality moving image by referring to the start time and ending time included in the received interested scene list. That is, the mobile phone 2 notifies the user of the positional information on the specified interested scene, which allows the user to reproduce quickly the interested scene with a simple manipulation. In other words, when the user wants to view only the interested scene, it is not necessary to search the interested scene while frequently performing reproduction at fast speed or rewinding reproduction. Therefore, battery consumption of the mobile phone 2 can be suppressed.

In the present embodiment, the pieces of processing in S105 to S111 are performed during the video recording of the moving image. However, the present invention is not limited thereto. For example, when the moving image reproducing unit 21 is stored in the moving image storage unit 30, or when the moving image received by the communication unit 16 is reproduced, the time t of the timer is set to 0, and the counting of the timer may be started when the reproduction of the moving image is started. That is, the pieces of processing in S105 to S111 are performed until the reproduction of the moving image is ended. For another example, when a moving image read unit (not shown) is stored in the moving image storage unit 30, or when the moving image received by the communication unit 16 is read, the time t of the timer is set to 0, and the counting of the timer may be started while the read of the moving image is started. That is, the pieces of processing in S105 to S111 are performed until the read of the moving image is ended.

The still image producing unit 26 reads the moving image frame to produce the still image at constant time intervals to. However, the present invention is not limited thereto. For example, the still image producing unit 26 may read all the moving image frames in the moving image to produce the still images.

In one or more embodiments of the present invention, the condition that is previously designated by the user to specify the interested scene is not limited to the character string such as the keyword illustrated above. However, the present invention is not limited thereto. For example, a face image of a person, an image of an object, or a sound may be used as the condition.

The processing of the DVD recorder 1 in the case where the user is interested in a player [symbol] in a baseball live program to set [symbol] as the keyword (interested information) will be described as a specific case example with reference to FIGS. 3 to 5 and FIGS. 7 to 10. In the present example, desirably the scene in which the player [symbol] appears is specified as the interested scene. Generally, in the baseball live program, a telop (caption) including the character string of [symbol] is displayed in the scene of at-bat of the player [symbol] . Therefore, the slot of the interested scene can automatically be specified by sensing whether the character string of [symbol] is included in the moving image. Hereinafter, it is assumed that the time interval t0 of the sensing target frame is set to one second.

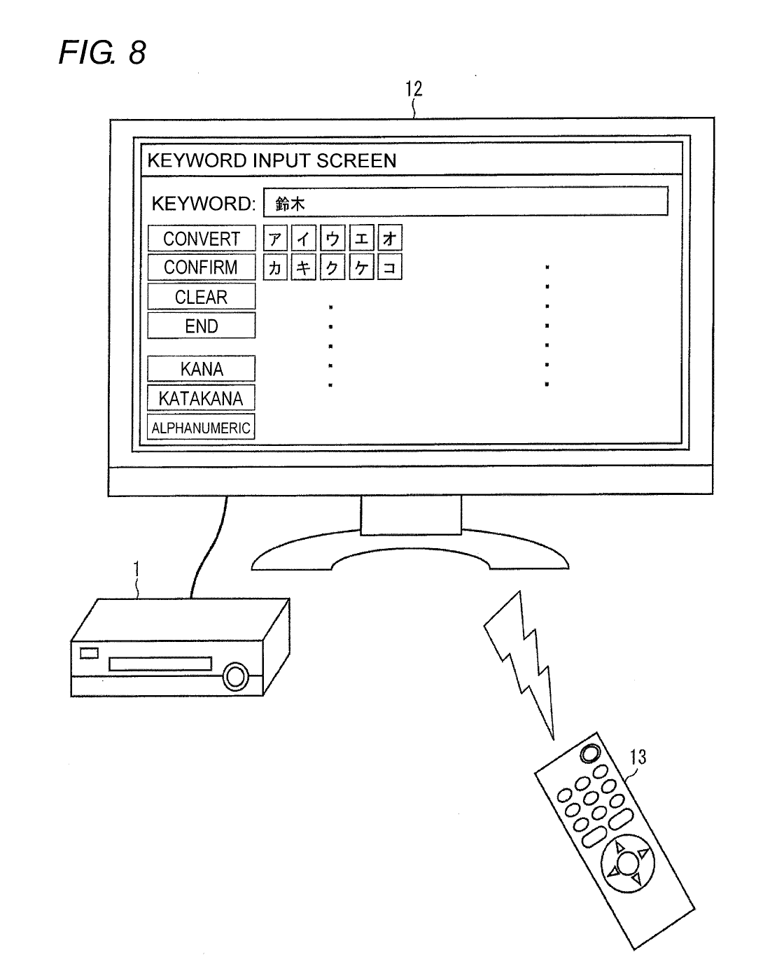

The manipulation in which the user inputs the keyword through the manipulation unit 13 in S101 will be described with reference to FIG. 8. FIG. 8 is a view describing appearances of the DVD recorder 1 of the present invention, the display device 12 (television), and the manipulation unit 13 (remote controller) and the state in which the user inputs the target keyword (character string). In the example shown in FIG. 8, the DVD recorder 1 outputs and displays, to and on the display device 12, the keyword input screen for the user to input the keyword. In the example shown in FIG. 8, the display device 12 displays the GUI screen on which the user can manipulate the manipulation unit 13 to input the designated keyword.

The user can manipulate the manipulation unit 13 to input the character string, which the user wants to find from the moving image of the processing target, to the DVD recorder 1. FIG. 8 shows an example in which the keyword [symbol] is inputted as the target character string.

When the keyword is inputted and the enter button of the manipulation unit 13 is pressed down, the keyword analysis unit 24 acquires the inputted keyword (for example, [symbol] ) to store the keyword in the keyword retaining unit 14b of the temporary storage unit 14.

In S102, the keyword analysis unit 24 searches each character code of the acquired keyword [symbol] from the character information stored in the character information storage unit 31 shown in FIG. 3, and the keyword analysis unit 24 extracts the feature quantity correlated with the matched character code. In the example shown in FIG. 3, when the keyword [symbol] has a character code “A123456”, a feature quantity [symbol] correlated with the character code “A123456” is extracted as the feature quantity of the keyword [symbol] . When the keyword [symbol] has a character code “A234567”, a feature quantity [symbol] correlated with the character code “A234567” is extracted as the feature quantity of the keyword [symbol] .

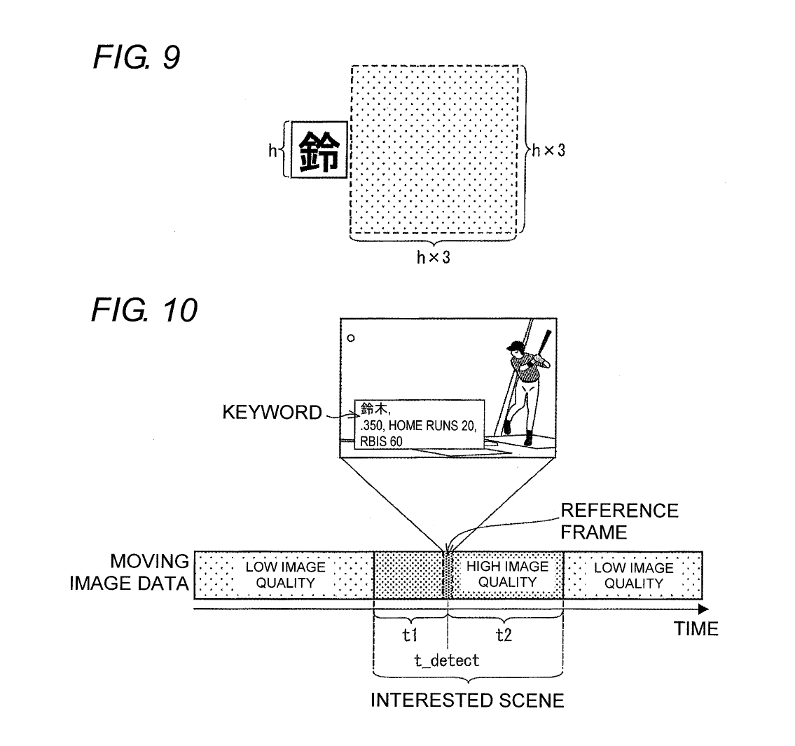

The video recording of the moving image is started, and the moving image frame at time intervals of one second is read to sense whether the keyword [symbol] is included in each read sensing target frame. In the present example, as shown in FIG. 4, it is assumed that the keyword sensing unit 25 senses the keyword [symbol] at the times 15 minutes 15 seconds and 32 minutes 45 seconds since the video recording is started. An example of keyword character string sensing processing performed by the keyword sensing unit 25 at this point will be described with reference to FIG. 9.

In the keyword character string sensing processing, for example, whether the keyword is included in the still image may be checked from the first character of the character string of the keyword. In this case, whether the feature quantity of the first character [symbol] exists in the feature quantity extracted from the still image produced from the sensing target frame is checked. When the feature quantity of the character [symbol] exists, a predetermined image region in the vicinity (for example, right side and lower side) of the feature quantity of the first character [symbol] is set to a search region to check whether the feature quantity of the second character [symbol] exists in the feature quantity extracted from the image in the search region. When the sensing is performed to the whole character string included in the keyword, the sensing target frame is specified as the reference frame, and the time t of the reference frame is stored as t_detect.

As to the predetermined image region (search region) in the vicinity of the image region where the feature quantity of the first character [symbol] is sensed, for example, as shown in FIG. 9, a 3 h×3 h region that is triple a character size (h×h) of the detected character [symbol] may be set to the search region (a hatched region in a broken-line frame shown in FIG. 9).

After the video recording of the moving image is ended, the interested scene specifying unit 23 specifies the period between the time t_start that is the time t1 before the time t_detect of the reference frame and the time tend that is the time t2 after the time t_detect of the reference frame as the slot of the interested scene as shown in FIG. 10. The interested scene specifying unit 23 stores the information on the interested scene shown in FIG. 5 in the interested scene storage unit 33.

As shown in FIG. 5, in the present example, the time t1 is set to “3 minutes” while the time t2 is set to “2 minutes” only by way of example. There are various methods for setting the time t1. For example, the times t1 and t2 may be set by default as a specific value of the apparatus, or the user may arbitrarily set the times t1 and t2.

There may be set a second keyword and a third keyword (uninterested information), which are different from the keyword (first keyword: interested information) [symbol] in the present example. In this case, the keyword sensing unit 25 sequentially extracts the sensing target frame backward in time from the reference frame with respect to the sensing target frame before the reference frame, and the keyword sensing unit 25 detects whether the feature quantity (uninterested feature quantity) of the second keyword (uninterested information) is included in the extracted sensing target frame. When the keyword sensing unit 25 senses the feature quantity (uninterested feature quantity) of the second keyword, the interested scene specifying unit 23 sets the sensing target frame to the interested scene start frame and sets the time of the interested scene start frame to the start time t_start of the interested scene. The keyword sensing unit 25 extracts the sensing target frame in the order of the time from the reference frame with respect to the sensing target frame after the reference frame, and the keyword sensing unit 25 senses whether the feature quantity (uninterested feature quantity) of the third keyword (uninterested information) is included in the extracted sensing target frame. When the keyword sensing unit 25 senses the feature quantity (uninterested feature quantity) of the third keyword, the interested scene specifying unit 23 sets the sensing target frame to the interested scene ending frame and sets the time of the interested scene ending frame to the ending time Lend of the interested scene.

That is, the second keyword may be set to the information used to sense the interested scene start frame while the third keyword is set to the information used to sense the interested scene ending frame. In other words, the first keyword is the interested information indicating the items in which the user is interested, and the second and third keywords are the uninterested information indicating information relating to the scene in which the user is not interested. The feature quantity extracted from the second or third keyword by the keyword analysis unit 24 is referred to as an uninterested feature quantity.

For example, in the present example, when a preceding batter of the player [symbol] and a batter subsequent to the player [symbol] are well known, a name of the preceding batter may be set to the second keyword while a name of the subsequent batter is set to the third keyword. Even if the preceding batter of the player [symbol] and the batter subsequent to the player [symbol] are unknown, because a position of the telop introducing the player is generally fixed in the moving image, the frame in which the other character string except [symbol] is detected may be set to the interested scene start frame or interested scene ending frame in the region where [symbol] is sensed on the image in the frames before and after the reference frame in which [symbol] is sensed. In addition, character strings such as “commercial message” and “provided by” which are likely to be displayed before the commercial message or a company name or a brand name of a sponsor of a program are set to the second and third keywords, which allows the interested scene to be separated by utilizing the commercial message. For the television program, the interested scene may be specified using metadata included in the moving image data.

As to another method for setting the period of the interested scene, in accordance with one or more embodiments of the invention, the interested scene specifying unit 23 may set the times (scene switching time point) of the sensing target frames having large image change amounts before and after the reference frame to the start time t_start or ending time t_end of the interested scene. Specifically, the scene switching time point detection unit 29 sequentially extracts the sensing target frame backward in time from the reference frame with respect to the sensing target frame before the reference frame (before the reference time point), and the scene switching time point detection unit 29 compares the image of the extracted sensing target frame and the frame images before and after the sensing target frame. When the image change amount between the frames (a feature quantity change amount of the image) exceeds a predetermined threshold, the scene switching time point detection unit 29 detects the time (time point) of the sensing target frame as the scene switching time point. The interested scene specifying unit 23 sets the scene switching time point, which is detected by the scene switching time point detection unit 29 before the reference time point, to the start time t_start. The scene switching time point detection unit 29 extracts the sensing target frame in the order of the time from the reference frame with respect to the sensing target frame after the reference frame (after the reference time point), and the scene switching time point detection unit 29 compares the image of the extracted sensing target frame and the frame images before and after the sensing target frame. When the image change amount between the frames (a feature quantity change amount of the image) exceeds the predetermined threshold, the scene switching time point detection unit 29 detects the time (time point) of the sensing target frame as the scene switching time point. The interested scene specifying unit 23 sets the scene switching time point, which is detected by the scene switching time point detection unit 29 after the reference time point, to the ending time t_end.

In the method for setting the slot (period) of the interested scene (method for selecting the scene switching time point), when the scene switching time point detection unit 29 detects a plurality of scene switching time points, the interested scene specifying unit 23 may select at least one of the start time point and ending time point of the slot of the interested scene from the plurality of scene switching time points detected by the scene switching time point detection unit 29. The interested scene specifying unit 23 may select the scene switching time point immediately before (or immediately after) the reference time point when selecting the start time point (or ending time point) from the plurality of scene switching time points. The interested scene specifying unit 23 may select the scene switching time point that is the plurality of time points away from the reference time point as the start time point (or ending time point) when selecting the start time point (or ending time point) from the plurality of scene switching time points. When selecting the start time point and ending time point from the plurality of scene switching time points, the interested scene specifying unit 23 may select the start time point and ending time point from the plurality of scene switching time points such that the slot of the interested scene becomes a predetermined time or more.

The scene switching time point detection unit 29 extracts the sensing target frame in the order from the reference time point with respect to the sensing target frames before and after the reference time point. However, the extracting order is not limited thereto. For example, the scene switching time point detection unit 29 may extract the sensing target frame in the order of the moving image time axis. The scene switching time point detection unit 29 sets the predetermined threshold to the constant value, and detects the time (time point) of the sensing target frame as the scene switching time point when the image change amount between the frames (feature quantity change amount of the image) exceeds the predetermined threshold. However, the present invention is not limited thereto. For example, the scene switching time point detection unit 29 may change the predetermined threshold used to determine the image change amount between the frames (feature quantity change amount of the image) in the sensing target frame as the time of the extracted sensing target frame is distant from the time (reference time point) of the reference frame. That is, the scene switching time point detection unit 29 may gradually decrease the predetermined threshold as the time of the extracted sensing target frame is distant from the time of the reference frame.

The image quality degrading unit 22 puts the image quality of the scene except the interested scene specified by the interested scene specifying unit 23 in the low image quality. When the image quality of the scene except the interested scene is degraded, the image quality of the interested scene becomes higher than that of the scene except the interested scene as a result. In the present example, when the moving image is 60 minutes, the period from the start 0 minutes 0 seconds to 12 minutes 15 seconds, the period from 17 minutes 15 seconds to 29 minutes 45 seconds, and the period from 34 minutes 45 seconds to 60 minutes 0 seconds are put in the low image quality. The period from 12 minutes 15 seconds to 17 minutes 15 seconds and the period from 29 minutes 45 seconds to 34 minutes 45 seconds are maintained in the original image quality.

In accordance with one or more embodiments of the invention, for example, the following methods are used as the specific method in which the image quality degrading unit 22 puts the scene except the interested scene in the low image quality. In a first example, the resolution of the image data is relatively increased for the interested scene while the resolution of the image data is relatively decreased for the scene except the interested scene. In a second example, the compression ratio of the moving image is relatively decreased for the interested scene while the compression ratio of the moving image is relatively increased for the scene except the interested scene. In a third example, the frame rate is relatively increased for the interested scene while the frame rate is relatively decreased for the scene except the interested scene. In the third example, a technique, in which an image of a predetermined frame and the frame images before and after the predetermined frame are compared to thin out the predetermined frame whose image change amount between the frames (feature quantity change amount of the image) is lower than a predetermined threshold, may be used as a method for thinning out the frame in decreasing the frame rate. In this case, the image of the predetermined frame and the frame images before and after the predetermined frame are compared to compute the image change amount between the frames. However, the present invention is not limited thereto. For example, the image of the predetermined frame may be compared to the frame image before the predetermined frame, or the image of the predetermined frame may be compared to the frame image after the predetermined frame.

For example, in the conventional art, contents of the moving image data are the baseball live program, and only the scene of the at-bat of the player in which the user is particularly interested is transferred to a mobile viewing terminal. In this case, because the pieces of moving image data of other scenes except the interested scene are not transferred to the mobile viewing terminal, the user cannot view the scene except the interested scene on the mobile viewing terminal. Therefore, the user cannot learn development of the game before and after the at-bat of the interested player, and a viewing value of the moving image transferred to the mobile viewing terminal is largely reduced.

On the other hand, in one or more embodiments of the present invention, the image quality degrading unit 22 of the DVD recorder 1 degrades the image quality of the slot except the interested scene to produce the low-image-quality moving image. Therefore, in the produced low-image-quality moving image, only the image quality of the slot except the interested scene becomes the low image quality while the image quality of the interested scene in which the user is probably interested is maintained. That is, in the produced low-image-quality moving image, the original image quality is maintained for the interested scene in which the user is interested, the pieces of information before and after the interested scenes are included, and the whole data amount is smaller than that of the original moving image. Therefore, the produced low-image-quality moving image can be used as the moving image transferred to another device. In such cases, the transfer time can be shortened, and the user can view the scenes before and after the interested scene on another device.

The present invention is not limited to the embodiments described above, but various changes can be made without departing from the scope of the claims. An embodiment obtained by appropriately combining technical means within the scope of the claims is also included in the technical range of the present invention.

Finally, each block of the image processing device 1, particularly the image quality degrading unit 22, the interested scene specifying unit 23, the keyword analysis unit 24, the keyword sensing unit 25, the still image producing unit 26, and the feature quantity extracting unit 27 may be formed by hardware logic or may be realized as follows by software using the CPU.

That is, the image processing device 1 includes the CPU (Central Processing Unit) that executes a command of a control program realizing each function, the ROM (Read Only Memory) in which the program is stored, the RAM (Random Access Memory) in which the program is expanded, and the storage device (recording medium) such as a memory in which the program and various pieces of data are stored. Program codes (an executable format program, an intermediate code program, and a source program) of the control programs that are the software realizing the above functions in the image processing device 1 are recorded in the recording medium while the computer can read the program codes, the recording medium is supplied to the image processing device 1, and the computer (or the CPU or MPU) reads and executes the program code recorded in the recording medium, which allows the object of the invention to be achieved.

Examples of the recording medium include tape system such as magnetic tape and cassette tape, disk systems including magnetic disks such as floppy disk (registered trademark) and a hard disk and optical disks such as a CD-ROM, an MO, an MD, a DVD, and a CD-R, card systems such as an IC card (including a memory card) and an optical card, and semiconductor memory systems such as a mask ROM, an EPROM, an EEPROM and a flash ROM.

The image processing device 1 is configured to be able to be connected to a communication network, and the program code may be supplied through the communication network. There is no particular limitation to the communication network. Examples of the communication network include the Internet, an intranet, an extranet, a LAN, an ISDN, a VAN, a CATV communication network, a virtual private network, a telephone line network, a mobile communication network, and a satellite communication network. There is no particular limitation to a transmission medium included in the communication network. Examples of the transmission medium include, although not limited thereto, wired lines such as IEEE 1394, a USB, a power-line carrier, a cable TV line, a telephone line, and an ADSL line and wireless lines such as infrared ray such as IrDA and a remote controller, Bluetooth (registered trademark), 802.11 wireless, HDR, a mobile telephone network, a satellite line, and a terrestrial digital network. The present invention can be realized in the form of a computer data signal embedded in a carrier wave in which the program code is embodied by electronic transmission.

The image processing device of the present invention can be applied to various image processing devices, such as a DVD recorder/player, a digital video recorder/player, a Blu-ray disk recorder/player, a digital video camera, a digital camera, a digital television, a personal computer, a mobile phone, a printer, and a scanner, which process the still image and/or the moving image.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An image processing device comprising:
an interested information sensing section for sensing a sound or a frame that is
inputted to the image processing device,
wherein the sound or frame constituting a moving image,
wherein the sound or frame comprises a feature quantity matched with an interested feature quantity, and
wherein the interested feature quantity is extracted from interested information indicating an item in which a user is interested;
an interested scene specifying section for specifying a slot comprising a reference time point as the interested scene on a reproducing time axis of the moving image,
wherein the reference time point is a time of the sound or frame,
wherein the sound or frame comprises the interested feature quantity, and
wherein the sound or frame is sensed by the interested information sensing section; and
a low-image-quality moving image producing section for degrading image quality of a slot except the interested scene specified by the interested scene specifying section in the moving image, wherein the low-image-quality moving image producing section produces a low-image-quality moving image of the moving image.

2. The image processing device according to claim 1, wherein the interested scene specifying section specifies a slot between a time point that is a predetermined time before the reference time point and a time point that is a predetermined time after the reference time point as the interested scene.

3. The image processing device according to claim 1,
wherein the interested information sensing section senses the sound or frame, which is inputted to the image processing device, the sound or frame constituting the moving image, the sound or frame comprising a feature quantity matched with an uninterested feature quantity,
wherein the uninterested feature quantity is extracted from uninterested information relating to a scene in which a user is not interested, and
the interested scene specifying section sets a time after the reference time point in a time of the sound or frame comprising the uninterested feature quantity as an ending time point of the interested scene,
wherein the time of the sound or frame is sensed by the interested information sensing section.

4. The image processing device according to claim 1, further comprising:
scene switching time point detection section for detecting a scene switching time point at which an image change amount between frames becomes a predetermined amount or more,
wherein the interested scene specifying section selects at least one of the start time point and the ending time point of the slot of the interested scene from the scene switching time point detected by the scene switching time point detection section.

5. The image processing device according to claim 4, wherein the interested scene specifying section selects the scene switching time point immediately before the reference time point and the scene switching time point immediately after the reference time point as the start time point and the ending time point of the slot of the interested scene from a plurality of scene switching time points detected by the scene switching time point detection section, respectively.

6. The image processing device according to claim 4, wherein the interested scene specifying section selects a start time point and an ending time point of the slot from the plurality of scene switching time points such that the slot of the interested scene becomes a predetermined time or more.

7. The image processing device according to claim 1, wherein the interested information includes at least one of text data, image data, and sound data.

8. The image processing device according to claim 1, wherein the low-image-quality moving image producing section decreases resolution of the slot except the interested scene specified by the interested scene specifying section in the moving image.

9. The image processing device according to claim 1, wherein the low-image-quality moving image producing section increases a moving image compression ratio of the slot except the interested scene specified by the interested scene specifying section in the moving image.

10. The image processing device according to claim 1, wherein the low-image-quality moving image producing section decreases a frame rate of the slot except the interested scene specified by the interested scene specifying section in the moving image.

11. The image processing device according to claim 10, wherein the low-image-quality moving image producing section compares an image of a predetermined frame and a frame image before the predetermined frame and decreases the frame rate by thinning out the predetermined frame whose image change amount between frames is lower than a predetermined threshold.

12. An image processing system comprising:
the image processing device according to claim 1; and
a mobile terminal that can reproduce a moving image,
wherein the image processing device transfers the produced low-image-quality moving image to the mobile terminal.

13. The image processing system according to claim 12, wherein the image processing device transfers information indicating the slot of the interested scene in the moving image to the mobile terminal.

14. An image processing method comprising:
sensing a sound or a frame, in an interested information sensing step, which constitutes a moving image,
wherein the sound or frame comprises a feature quantity matched with an interested feature quantity, and
wherein the interested feature quantity is extracted from interested information indicating an item in which a user is interested;
specifying a slot, in an interested scene specifying step, comprising a reference time point as the interested scene on a reproducing time axis of the moving image,
wherein the reference time point is a time of the sound or frame, and
wherein the sound or frame is sensed in the interested information sensing step; and
degrading image quality of a slot, in a low-image quality moving image producing step, except the interested scene specified in the interested scene specifying step in the moving image and producing a low-image-quality moving image of the moving image.

15. The image processing method according to claim 14, further comprising:
transferring the low-image-quality moving image produced in the low-image-quality moving image producing step to a mobile terminal.

16. (canceled)

17. A non-transitory computer-readable medium comprising a control program when executed on a processor, performs a method, the method comprising:
sensing a sound or a frame in an interested information sensing step, which constitutes a moving image,
wherein the sound or frame comprises a feature quantity matched with an interested feature quantity, and
wherein the interested feature quantity is extracted from interested information indicating an item in which a user is interested;
specifying a slot, in an interested scene specifying step, comprising a reference time point as the interested scene on a reproducing time axis of the moving image,
wherein the reference time point is a time of the sound or frame, and
wherein the sound or frame is sensed in the interested information sensing step; and
degrading image quality of a slot, in a low-image quality moving image producing step, except the interested scene specified in the interested scene specifying step in the moving image and producing a low-image-quality moving image of the moving image.

18. The computer-readable medium of claim 17, further comprising:
transferring the low-image-quality moving image produced in the low-image-quality moving image producing step to a mobile terminal.

19. The image processing device according to claim 2, wherein the interested information includes at least one of text data, image data, and sound data.

20. An image processing system comprising:
the image processing device according claim 2; and
a mobile terminal that can reproduce a moving image,
wherein the image processing device transfers the produced low-image-quality moving image to the mobile terminal.

21. The image processing system according to claim 20, wherein the image processing device transfers information indicating the slot of the interested scene in the moving image to the mobile terminal.
